(19) United States
(12) Patent Application Publication
(10) Pub. No.: US 2020/0234835 A1
(43) Pub. Date: Jul. 23, 2020

(54) COOLANT RECIRCULATION SYSTEM OF NUCLEAR POWER PLANT

(71) Applicant: KOREA ATOMIC ENERGY RESEARCH INSTITUTE, Daejeon (KR)

(72) Inventors: Jonghyuk LEE, Daejeon (KR); Kyungdoo KIM, Incheon (KR); Kwiseok HA, Daejeon (KR); Sungwon BAE, Daejeon (KR); Seungwook LEE, Daejeon (KR); Chiwoong CHOI, Sejong-si (KR); Jaeseok HEO, Daejeon (KR)

(73) Assignee: KOREA ATOMIC ENERGY RESEARCH INSTITUTE, Daejeon (KR)

(21) Appl. No.: 16/743,414

(22) Filed: Jan. 15, 2020

(30) Foreign Application Priority Data
Jan. 22, 2019 (KR) 10-2019-0008285

(51) Int. Cl. G21C 15/16; F22B 37/00; F22B 37/26; G21D 5/12

(52) U.S. Cl. CPC G21C 15/16; F22B 37/002; F22B 37/263; G21D 5/12; F22B 37/268

(57) ABSTRACT

A coolant recirculation system of a nuclear power plant is provided that may include: a reactor vessel configured to accommodate a reactor core and a reactor coolant therein; a steam generator configured to transfer a gas, converted from a liquid phase to a gaseous phase by exchanging heat with the reactor coolant, to a turbine system; a pressurizer configured to control pressure of the reactor coolant in the reactor vessel; a primary system pressure reducing valve located above the pressurizer and configured to open at a predetermined pressure to discharge the reactor coolant into a containment building for rapid depressurization; and a moisture separator connected to the primary system pressure reducing valve to separate moisture. The moisture separator may separate the reactor coolant into a gaseous phase and a liquid phase. Then, the liquid phase reactor coolant may be returned to the reactor vessel to be recirculated.

### CROSS-REFERENCE TO RELATED APPLICATION

Pursuant to 35 U.S.C. § 119(a), this application claims the benefit of the earlier filing date and the right of priority to Korean Patent Application No. 10-2019-0008285, filed on Jan. 22, 2019, the contents of which is incorporated by reference herein in its entirety.

### BACKGROUND

### 1. Technical Field

The present discloses relates to a reactor coolant recirculation system of a nuclear power plant, and more particularly, to a reactor coolant recirculation system designed to prevent an outflow of reactor coolant discharged during rapid depressurization.

### 2. Description of the Related Art

Primary system pressure reducing valves, such as a pilot operated safety relief valve or a safety relief valve, are widely used for the purpose of prevention of over-pressurization and rapid depressurization of a primary system of a nuclear reactor. A primary system pressure reducing valve is installed at an upper side of a pressurizer of a nuclear power plant, which is a valve that can perform a safety valve function and a safety pressure relief function for a Reactor Coolant System (RCS).

In detail, the primary system pressure reducing valve is one of important components of the nuclear power plant designed to open at a predetermined set pressure to prevent over-pressurization of the primary system, or used to perform rapid depressurization by manual operation (or action) due to factors such as core outlet temperature. Specifically, the primary system pressure reducing valve performs functions of a pressurizer safety valve for domestic (South Korea) pressurized water reactors such as OPR-1000, APR-1400, and System-integrated Modular Advanced Reactor (SMART), and for overseas commercial reactors.

When the primary system pressure reducing valve is opened for the purpose of rapid depressurization, a primary reactor coolant is discharged. Here, the primary reactor coolant is discharged in the form of a mixed fluid of gas and liquid.

For efficient depressurization of reactor systems, it is desirable to discharge a reactor coolant in a gaseous state having a higher thermal energy than a reactor coolant in a liquid state having a relatively low thermal energy. However, when the primary system pressure reducing valve is opened, a mixed fluid of gas and liquid may be discharged, or a liquid phase reactor coolant may only be discharged as time has elapsed. When an excessive amount of liquid phase reactor coolant is discharged, core uncovery may occur due to a decrease in reactor coolant inventory in a reactor vessel. That is, an increased discharge amount of liquid phase coolant may lead to a decrease in depressurization rate and reactor core damage.

### SUMMARY

Embodiments disclosed herein provide a reactor coolant recirculation system that can minimize a discharge amount of reactor coolant in a liquid state during rapid depressurization.

Embodiments disclosed herein also provide a reactor coolant recirculation system that may include a reactor vessel configured to accommodate a reactor core and a reactor coolant therein, a steam generator configured to transfer a gas, converted from a liquid phase to a gaseous phase by exchanging heat with the reactor coolant, to a turbine system, a pressurizer connected to the reactor vessel and configured to control pressure of the reactor coolant in the reactor vessel, a primary system pressure reducing valve located above the pressurizer and configured to open at a predetermined pressure or manually operated by an operator so as to discharge the reactor coolant for rapid depressurization, and a moisture separator connected to the primary system pressure reducing valve to separate moisture. The moisture separator may the reactor coolant into a gaseous phase and a liquid phase. The liquid phase reactor coolant may be returned to the reactor vessel so as to be recirculated.

According to an embodiment disclosed herein, the moisture separator may be provided at a pipe connected to the primary system pressure reducing valve.

According to an embodiment disclosed herein, the gaseous phase reactor coolant separated by passing through the moisture separator may only be fed to the primary system pressure reducing valve to be discharged, when the primary system pressure reducing valve is opened.

According to an embodiment disclosed herein, the liquid phase reactor coolant separated by passing through the moisture separator may be returned to the reactor vessel, when the primary system pressure reducing valve is opened.

According to an embodiment disclosed herein, a circulation pipe extendedly connected to the moisture separator may be provided. The liquid phase reactor coolant separated by the moisture separator may be returned to the reactor vessel through the circulation pipe.

According to an embodiment disclosed herein, the circulation pipe may be connected to a pipe through which the reactor coolant is supplied to the reactor vessel. The circulation pipe may be connected to at least one of a pipe extendedly connected to an outlet of the steam generator, or a cold leg connected to the reactor vessel.

According to an embodiment disclosed herein, the reactor vessel may to further include a safety injection system. The safety injection system may include a cooling water accommodating portion configured to accommodate cooling water therein, and a cooling water supply pipe. The cooling water accommodated in the cooling water accommodating portion may be fed to the reactor vessel through the cooling water supply pipe.

According to an embodiment disclosed herein, the circulation pipe may be connected to the cooling water supply pipe.

Embodiments disclosed herein may further provide a nuclear power plant that may include the reactor coolant recirculation system described above.

### BRIEF DESCRIPTION OF THE DRAWINGS

FIG. 1 is a conceptual view illustrating a coolant circulation system of a nuclear power plant according to one embodiment of the present disclosure.

FIG. 2 is a conceptual view illustrating a coolant circulation system of a nuclear power plant according to another embodiment of the present disclosure.

FIG. 3 is a graph illustrating enthalpy ratio (enthalpy of gaseous phase/enthalpy of liquid phase) with respect to a pressure change.

### DETAILED DESCRIPTION OF EMBODIMENTS

Description will now be given in detail according to exemplary embodiments disclosed herein, with reference to the accompanying drawings.

For the sake of brief description with reference to the drawings, the same or equivalent components may be provided with the same or similar reference numbers, and description thereof will not be repeated. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

The present disclosure relates to a reactor coolant recirculation system and a nuclear power plant having the reactor coolant recirculation system.

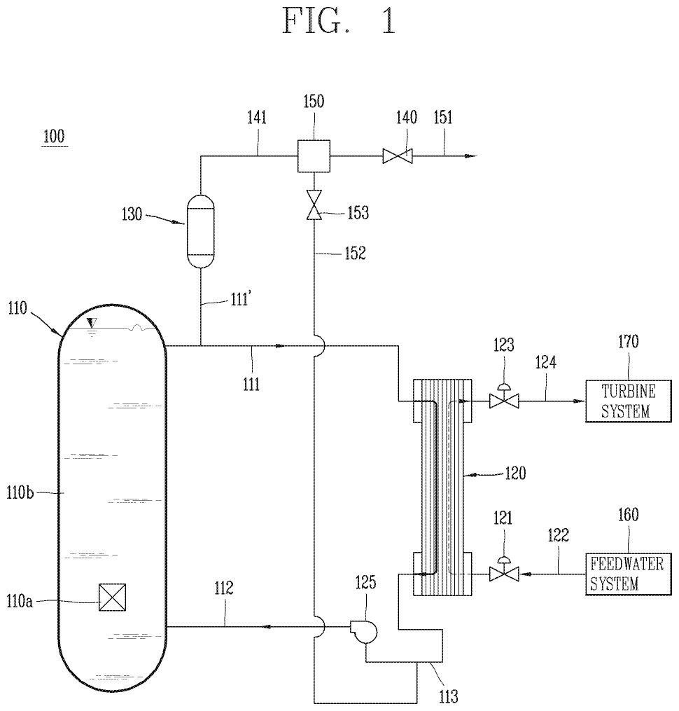

FIG. 1 is a conceptual view of a reactor coolant recirculation system 100 according to one embodiment of the present disclosure.

Referring to FIG. 1, the reactor coolant recirculation system 100 of the present disclosure may include a containment building (not shown), a reactor vessel 110, a steam generator 120, a pressurizer 130, a primary system pressure reducing valve 140, and a moisture separator 150. In more detail, the reactor coolant recirculation system 100 may be provided inside the containment building (not shown), and include the reactor vessel 110, the steam generator 120, the pressurizer 130, the primary system pressure reducing valve 140, and the moisture separator 150.

As illustrated, the reactor vessel 110 may accommodate a reactor core 110a (or core), and a reactor coolant (or coolant) 110b used to remove heat from the reactor core 110a therein. Heat is produced in the reactor core 110a by the fission of fuel. The heat generated in the reactor core 110a may be passed to the reactor coolant 110b to be transferred to the steam generator 120.

The steam generator 120 may form a pressure boundary between a primary system and a secondary system. A primary coolant (water) may flow into one flow channel or path and a secondary coolant (water) may flow into the other flow channel, so that heat is transferred. The reactor coolant 110b at high temperature may be fed to the steam generator 120 via a pipe 111. That is, the reactor coolant 110b that serves as a high-temperature primary coolant is cooled by heat exchange, and is then forcedly circulated by motive power of a reactor coolant pump 125 through a pipe 112.

Meanwhile, feedwater (low temperature, secondary coolant) supplied from a feedwater system 160 through a valve 121 and a pipe 122 may be converted into steam by absorbing heat. The generated steam may be supplied to a turbine system 170 through a valve 123 and a pipe 124 to generate electricity.

The steam generator 120 may be disposed outside the reactor vessel 110, as illustrated in FIG. 1. However, this is just one example, and a location of the steam generator 120 is not limited thereto. In other words, in another embodiment, the steam generator 120 may be an integral reactor disposed inside the reactor vessel 110.

A pipe 111′ may be branched from the pipe 111 that connects the reactor vessel 110 and the steam generator 120. The pressurizer 130 may be disposed at the pipe 111′. In pressurized water reactors, in particular, the pressurizer 130 is used to pressurize the reactor coolant 110b to an over-pressurized state below saturation temperature (boiling point) and pressure, and to control pressure. In detail, the pressurizer 130 prevents vapor from being produced when the reactor coolant 110b is circulated.

The primary system pressure reducing valve 140 may be located above the reactor vessel 110. The primary system pressure reducing valve 140 is mainly used to prevent over-pressurization or overpressure of a system, and is usually designed to perform a function of rapid depressurization. In particular, when the primary system pressure reducing valve 140 is opened for the purpose of rapid depressurization, the reactor coolant 110b may be discharged into a storage tank (not shown). At this time, the reactor coolant 110b may be discharged in the form of a mixed fluid, which is a mixture of gas and liquid.

When the primary system pressure reducing valve 140 is opened for the purpose of rapid depressurization, it may be more desirable to discharge a gaseous phase fluid having a higher thermal energy than a liquid phase fluid having a relatively low thermal energy for efficient depressurization of the reactor system.

In some cases, however, when the primary system pressure reducing valve 140 is opened, a mixed fluid of gas and liquid may be discharged, or a reactor coolant in a liquid state may only be discharged as time has elapsed. As the reactor coolant in the liquid state is discharged by opening the primary system pressure reducing valve 140, more amount of the reactor coolant 110b may be released. As a result, the reactor core 110a may be exposed to above a water level, causing damage on the reactor core 110a.

In other words, when the reactor coolant in the liquid state is discharged by opening the primary system pressure reducing valve 140, it may cause a huge problem in safety of the nuclear power plant.

Accordingly, in order to improve safety of the nuclear power plant, the reactor coolant 110b should be prevented from being massively or excessively discharged when opening the primary system pressure reducing valve 140. Therefore, the moisture separator 150 capable of separating a liquid phase fluid from a gaseous phase fluid may be provided at an extended portion of the pipe 111′, so that the gaseous phase fluid having a high thermal energy and the liquid phase fluid of the reactor coolant 110b are separated from each other.

In other words, the moisture separator 150 may be connected to the primary system pressure reducing valve 140 to separate moisture. The moisture separator 150 may be configured to separate a two-phase flow. The two-phase flow may be defined as a flow of gas and liquid.

In one embodiment, the moisture separator 150 configured to separate the two-phase flow using centrifugal force may be provided.

In detail, when the-two phase flow is rotated in the moisture separator 150, a liquid phase fluid is moved to an inner wall of the moisture separator 150 by the centrifugal force and is then agglomerated. The agglomerated liquid phase fluid may flow through the inner wall to be collected or gathered on one side of the moisture separator 150.

In the moisture separator 150, the centrifugal force may be generated by external power, or may be generated as the two-phase flow moves along a flow channel having a circular shape.

A process of separating the gaseous phase fluid and the liquid phase fluid by the moisture separator 150 is a well-known technology, so a detailed description thereof will be omitted.

Further, the reactor coolant 110b in the gaseous state having a high thermal energy, which is separated by the moisture separator 150, may be discharged via a discharge pipe 151 to be more efficiently depressurized.

On the other hand, the reactor coolant 110b in the liquid state, which is separated by the moisture separator 150, may be sent back to the reactor vessel 110 through a circulation pipe 152 to be recirculated. The circulation pipe 152 may be connected to the pipe 112 through which a reactor coolant heat-exchanged with the steam generator 120 is fed to the reactor vessel 110. That is, the reactor coolant 110b in the liquid state is separated by the moisture separator 150, and is then returned to the reactor vessel 110 through the circulation pipe 152, thereby preventing an excessive outflow (or runoff) of the nuclear coolant 110b.

As shown in FIG. 1, the moisture separator 150 of the reactor coolant recirculation system 100 may be provided at a front end of the primary system pressure reducing valve 140. That is, when rapid depressurization is carried out using the primary system pressure reducing valve 140, a mixture of gas and liquid reactor coolant that has passed through the pressurizer 130 is separated into a liquid phase and a gaseous phase by the moisture separator 150.

Subsequently, the gaseous phase liquid coolant is supplied to the primary system pressure reducing valve 140, and is then discharged into a storage tank (not shown) through the discharge pipe 151.

On the other hand, the liquid phase reactor coolant is sent back to the reactor vessel 110 through the circulation pipe 152 and the valve 153 to be recirculated.

In one embodiment, the valve 153 may be opened at a predetermined set pressure as in the primary system pressure reducing valve 140. When the valve 153 is opened at the set pressure, the reactor coolant 110b in the liquid phase, which is separated by the moisture separator 150, is moved from the moisture separator 150 to the pipe 113 by a head difference. Water head of the moisture separator 150 may be greater than that of the pipe 113.

In addition, the valve 153 may be configured to open to only one side, (or allow fluid to flow through it in only one direction). The one side may be referred to as a lower side of the valve 153 with respect to FIG. 1. In one embodiment, the valve 153 may be configured as a check valve.

In detail, when pressure of the moisture separator 150 is higher than pressure of the pipe 113, the reactor coolant 110b may flow to the pipe 113 through the opened one side of the valve 153.

In contrast, when the pressure of the moisture separator 150 is lower than the pressure of the pipe 113, the valve 153 is blocked or closed to suppress movement of the reactor coolant 110b.

This may prevent backflow of the reactor coolant 110b into the moisture separator 150 due to a pressure difference.

That is, the reactor coolant 110b in the liquid state may be sent back to the reactor vessel 110 through the circulation pipe 152 to be recirculated.

In other words, the circulation pipe 152 may be formed such that a reactor coolant in the liquid state separated by the moisture separator 150 is fed to the reactor vessel 110. The reactor coolant may be supplied by a head difference between the moisture separator 150 and the pipe 113. The circulation pipe 152 may be connected to a pipe extendedly connected to an outlet of the steam generator 120.

In detail, the circulation pipe 152 may be connected to the pipe 113 between the reactor coolant pump 125 and the steam generator 120, so that the reactor coolant in the liquid state, which is separated using the moisture separator 150 by the motive power of the reactor coolant pump 125, is supplied to the reactor vessel 110.

Further, the circulation pipe 152 may be connected to the pipe 112 between the reactor coolant pump 125 and the reactor vessel 110, so that the reactor coolant in the liquid state, separated by the moisture separator 150, is fed to the reactor vessel 110.

In the reactor coolant recirculation system according to embodiments disclosed herein, a gaseous phase fluid separated by passing through the moisture separator 150 may be discharged into the primary system pressure reducing valve 140. In addition, a liquid phase fluid may be recirculated by pressure of a mixed fluid of gas and liquid introduced into the moisture separator 150.

Further, in another embodiment, the circulation pipe 152 may be connected to a pipe (cold leg) connected to the reactor vessel 110. In other words, the circulation pipe 152 may be connected to an injection system pipe connected to a cooling water supply pipe or a new pipe only if a reactor coolant in the liquid state is returned to the reactor vessel 110 to be recirculated.

In the following embodiment, the same or similar reference numerals are designated to the same or similar configurations to the previous embodiment, and the description thereof will be substituted by the earlier description.

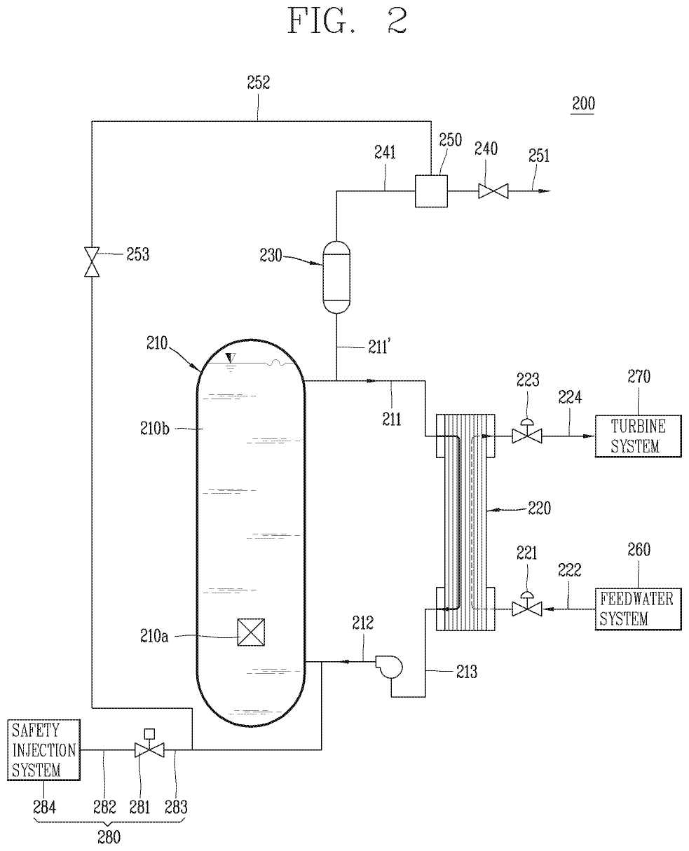

FIG. 2 is a conceptual view of a reactor coolant recirculation system 200 according to another embodiment of the present disclosure. Referring to FIG. 2, the reactor coolant recirculation system 200 may further include a safety injection system 280. The safety injection system 280 may be configured to supply cooling water (safety injection water or boric acid water) in various ways in a nuclear power plant accident. The safety injection system 280 may be configured such that a primary system is depressurized using a primary system pressure reducing valve 240 and cooling water is injected when a predetermined set safety injection system pressure is reached.

In one embodiment, a nitrogen pressurized safety injection tank (or accumulator) is used to quickly supply cooling water to a nuclear reactor. In addition, a low-pressure safety injection pump and a high-pressure safety injection pump may be used.

The safety injection system 280 may include cooling water accommodating portion 284 and cooling water supply pipes 282 and 283. In detail, cooling water accommodated in the cooling water accommodating portion 284 may be supplied to a reactor vessel 210 through the cooling water supply pipes 282 and 283. That is, the cooling water may be fed to the reactor vessel 210 through the cooling water supply pipes 282 and 283, and a valve 281.

Meanwhile, a reactor coolant in the liquid state separated by a moisture separator 250 may be sent back to the reactor vessel 210 through a circulation pipe 252, so as to be recirculated. In detail, the circulation pipe 252 may be connected to the cooling water supply pipe 283 so as to supply the liquid phase reactor coolant separated by the moisture separator 250 to the reactor vessel 210. In other words, the reactor coolant in the liquid state separated from the moisture separator 250 may be fed to the reactor vessel 210 regardless of whether the valve 281 of the safety injection system 280 is opened or closed.

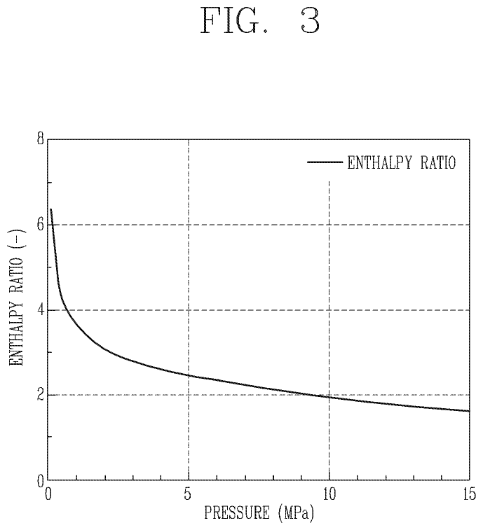

FIG. 3 is a graph illustrating enthalpy ratio (enthalpy of gaseous phase/enthalpy of liquid phase) with respect to a pressure change.

Referring to FIG.3, it can be seen that enthalpy ratio of gaseous phase to liquid phase increases as pressure is decreased. Accordingly, an operating pressure for primary pressure reducing valve operation (or opening) is a relatively high pressure. However, as the pressure is gradually reduced, inefficient depressurization occurs compared to a decrease in reactor coolant inventory.

Therefore, in the reactor coolant recirculation system according to embodiments disclosed herein, a mixed fluid of gas and liquid is separated by the moisture separator, and a gaseous phase coolant having a high thermal energy is only discharged, thereby enabling efficient depressurization. On the other hand, a liquid phase coolant having a relatively low thermal energy is recirculated, thereby preventing a core uncovery accident caused by a decrease in reactor coolant inventory in the reactor vessel.

It is obvious to those skilled in the art that the present disclosure can be embodied in other specific forms without departing from the concept and essential characteristics thereof.

The above detailed description should not be limitedly construed and should be considered illustrative in all aspects. Therefore, all changes and modifications that fall within the metes and bounds of the claims, or equivalents of such metes and bounds are therefore intended to be embraced by the appended claims.

In a reactor coolant recirculation system according to embodiments, a primary system pressure reducing valve configured to perform a function of rapid depressurization by discharging a reactor coolant may be provided. The primary system pressure reducing valve may be automatically opened at a predetermined set pressure, and/or manually operated by an operator. Further, a moisture separator connected between a pressurizer and the primary system pressure reducing valve may be provided, so that the reactor coolant is separated into a liquid phase and a gaseous phase. Then, the gaseous phase reactor coolant having a high thermal energy is discharged. This allows efficient depressurization to be ensured, when the primary system pressure reducing valve is opened for rapid depressurization.

In addition, in the reactor coolant recirculation system according to embodiments, the moisture separator may be connected to a front end of the primary system pressure reducing valve to separate moisture, so that a reactor coolant in a gaseous state and a reactor coolant in a liquid state are separated from each other. Then, the reactor coolant in the liquid state may be returned to a reactor vessel to be recirculated. As a result, reactor core damage caused by excessive reactor coolant discharge can be prevented. Further, as the reactor coolant in the liquid state is returned to the reactor vessel to be recirculated, safety of a nuclear power plant can be enhanced.

What is claimed is:

1. A reactor coolant recirculation system, comprising:
a reactor vessel configured to accommodate a reactor core and a reactor coolant therein;
a steam generator configured to transfer a gas, converted from a liquid phase to a gaseous phase by exchanging heat with the reactor coolant, to a turbine system;
a pressurizer connected to the reactor vessel, and configured to control pressure of the reactor coolant in the reactor vessel;
a primary system pressure reducing valve located above the pressurizer, and configured to open at a predetermined set pressure or manually operated by an operator, so as to discharge the reactor coolant for rapid depressurization; and
a moisture separator connected to the primary system pressure reducing valve to separate moisture,
wherein the moisture separator separates the reactor coolant into a gaseous phase and a liquid phase, and wherein the liquid phase reactor coolant is returned to the reactor vessel so as to be recirculated.

2. The system of claim 1, wherein the moisture separator is provided at a pipe connected to the primary system pressure reducing valve.

3. The system of claim 2, wherein the gaseous phase reactor coolant separated by passing through the moisture separator is only fed to the primary system pressure reducing valve to be discharged, when the primary system pressure reducing valve is opened.

4. The system of claim 2, wherein the liquid phase reactor coolant separated by passing through the moisture separator is returned to the reactor vessel, when the primary system pressure reducing valve is opened.

5. The system of claim 4, further comprising a circulation pipe extendedly connected to the moisture separator,
wherein the liquid phase reactor coolant separated by the moisture separator is returned to the reactor vessel through the circulation pipe.

6. The system of claim 5, wherein the circulation pipe is connected to a pipe through which the reactor coolant is supplied to the reactor vessel, and
wherein the circulation pipe is connected to at least one of a pipe extendedly connected to an inlet of reactor coolant pump, or a cold leg connected to the reactor vessel.

7. The system of claim 5, wherein the reactor vessel further comprises a safety injection system,
wherein the safety injection system comprises:
a cooling water accommodating portion configured to accommodate cooling water therein; and
a cooling water supply pipe, and
wherein the cooling water accommodated in the cooling water accommodating portion is fed to the reactor vessel through the cooling water supply pipe.

8. The system of claim 7, wherein the circulation pipe is connected to the cooling water supply pipe.

9. A nuclear power plant, comprising the reactor coolant recirculation system of claim 1.
